(19) United States
(12) Patent Application Publication
(10) Pub. No.: US 2015/0058061 A1
(43) Pub. Date: Feb. 26, 2015

(54) ZONAL ENERGY MANAGEMENT AND OPTIMIZATION SYSTEMS FOR SMART GRIDS APPLICATIONS

(71) Applicants: Magdy Salama, Waterloo (CA); Walid Morsi Ibrahim, Waterloo (CA); Ramadan El-Shatshat, Waterloo (CA); Haytham Mostafa, Waterloo (CA)

(72) Inventors: Magdy Salama, Waterloo (CA); Walid Morsi Ibrahim, Waterloo (CA); Ramadan El-Shatshat, Waterloo (CA); Haytham Mostafa, Waterloo (CA)

(21) Appl. No.: 13/975,882

(22) Filed: Aug. 26, 2013

(51) Int. Cl. G06Q 10/06

(52) U.S. Cl. CPC G06Q 10/06312
USPC 705/7.22

(57) ABSTRACT

An energy management and optimization system for smart grids is proposed to manage available zonal tools and resources to fulfill the objectives of a decision maker. The present invention is based on an efficient energy management system that monitors and manages the power of a zonal segment of the power system, at a flexible scale while taking into account the nature and characteristics of the zone. The system can be easily integrated with existing single unit and whole system.

### FIELD OF THE INVENTION

The present invention relates to energy management and optimization system for smart grids that manages the available zonal tools and resources to fulfill the objectives of a decision maker.

### BACKGROUND AND SUMMARY OF THE INVENTION

Electric energy distribution systems should be managed and optimized to save energy, improve efficiency, enhance reliability, and maintain security at a minimum operating cost. Energy management systems (EMS) can be categorized into two types: single unit EMS, and whole system EMS. The single unit EMS relates to commercial and residential buildings, where rooms could change their use with time. The designed EMS should be able to take into account the household energy consumption profiles of electrical appliances at low cost (U.S. Pat. No. 4,425,628 to Bedard et al., U.S. Pat. No. 8,335,596 to Raman et al., U.S. Patent Application No. 2012/0232701 A1 to Carty et al.). The whole system EMS refers to managing system generation, transmission, distribution, and loads. Centralized energy management in distributed systems (CEMS) is proposed in the U.S. Patent Application No. 2010/0100252 A1 to Kradjet et al., and U.S. Pat. No. 6,922,614 B2 to Le Van Suu et al. The main disadvantages of CEMS are: (i) reduced flexibility as modifications are needed for each additional components, and (ii) extensive computational requirements to perform the optimization. Another type of energy management system is distributed energy management systems (DEMS), which is based on multi agent system (U.S. Patent Application No. 2009/0157835 A1 to Thompson et al.). DEMS main advantage is flexibility as it provides the plug-and-play feature. However, using multi-agents, full control of different components will be difficult due to lack of information, which leads to reduced cooperation between different elements and the centralized controller. When tackling utility owned EMS, it is necessary to comprehend and study a control system called distribution management system (DMS). DMS acts as a decision support system to assist the control center with the monitoring and control of the electric distribution system. As a result, DMS improves the distribution system reliability and power quality by reducing the number of outages, minimizing outage time, and maintaining acceptable frequency and voltage levels. However, integrating additional functions in the DMS is not a simple action. DMS fails to offer scalability, functionality and operational capabilities required for managing a large number of distributed and demand-side resources, which do not cope with the modern distributed trend in distribution systems.

Most energy systems introduced so far, do not facilitate system infrastructural variations, or objective changes. In other words, each EMS is designed only to be applied on its corresponding system that it was originally designed for. Moreover, most of the surveyed EMS are designed for single objective optimization, operational cost minimization, or profit maximization.

Large industrial facilities, educational institutions, residential subdivisions, distribution system subdivision are typical zones that are not yet served by any of the available energy management products in the way described above. This segment of the market has unique characteristics that it is relatively large in size to be handled by single unit EMS, and at the same time, it has many customer specific features and requirements to be served by the current whole system EMS. This niche market is the main motivation for providing the present invention.

The main objective of the present invention is to provide an efficient energy management system that can monitor and manage the power of a zonal segment of the power system, at a flexible scale while taking into account the nature and characteristics of the zone. Furthermore, the system is designed so that it can be easily integrated with existing single unit and whole system EMS. The new Zonal Energy Management and Optimization System (ZEMOS) overcomes the aforementioned deficiencies of the existing EMS. This is achieved by providing custom built-in functions in modular forms that enables expansion and facilitates the integration of ZEMOS in different zones.

### SUMMARY OF THE INVENTION

The present invention assists the zone owner to save energy and improves the utilization of resources. From a utility perspective, ZEMOS is installed at a distribution system sub-division, and utilizes the sub-division resources in order to efficiently operate the system and reduce utility operational cost and defer zonal system components upgrades. From a customer perspective, ZEMOS is able to fulfill many objectives over different time periods. Furthermore, from an operational perspective, ZEMOS forecasts the system behavior during a specific study period, and consequently, recommends a possible energy flow that fulfills the operator's or zone owner's objectives during the study period. Once an objective is selected, it activates specific tools, or resources, from the resources and tools module. The activated tool states is optimally evaluated to fulfill the desired objective.

The first objective of the present invention is to have custom defined modular built-in functions to be easily integrated with existing monitoring and controlling systems in the defined zone.

The second objective of the present invention is to have a modular structure in which each module can be updated and expanded separately without affecting the whole system infrastructure.

The third objective of the present invention is to have a system to have the ability to handle both single and multiple objectives of a decision maker.

To achieve the above mentioned objectives, a zonal energy management and optimization system is proposed. ZEMOS contains custom defined built-in functions in a modular structure that can be integrated with other existing energy management systems in the zone of interest (industrial facilities, commercial centers, educational institutions, to name a few). ZEMOS functions might include minimizing greenhouse gas emissions, minimizing energy costs and losses, installation cost of new equipment, scheduling the zonal loads, and power quality improvement.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram illustrating the general flowchart of the method;

FIG. 2 shows the three basic steps of smart matching scheme (SMS);

FIG. 3 shows the flowchart of the sensitivity index generation and cost evaluation method;

FIG. 4 shows a block diagram of the proposed ZEMOS with seven modules used to construct the basic structure of ZEMOS; and

FIG. 5 shows the three parts of the input module.

### DETAILED DESCRIPTION OF PREFERRED EMBODIMENTS

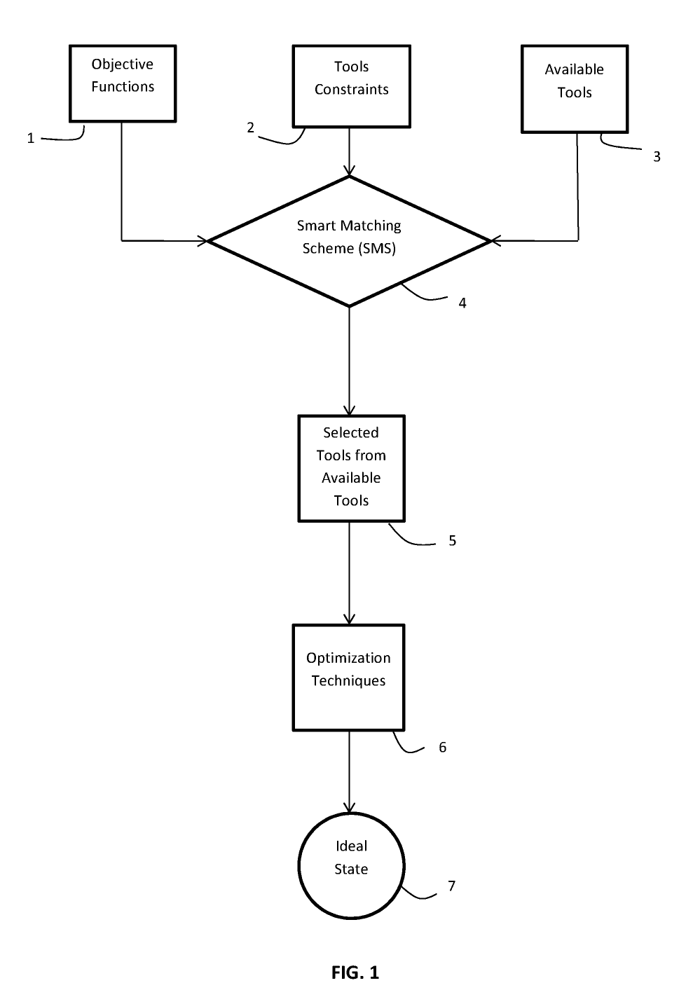

The general flowchart of the method is shown in FIG. 1. ZEMOS manages the available zonal tools and resources in order to fulfill the decision maker's objectives. The objectives of the decision maker are called Objective Functions 1, the available zonal tools are called Available Tools 3, and the limitations of the tools are called Tools Constraints 2.

The Smart Matching Scheme (SMS) 4 is used to match the existing zonal tools to the corresponding decision maker's objectives. The purpose of this matching algorithm is to reduce the operational time of ZEMOS by reducing the number of decision variables. This is done by avoiding the utilization of the zonal tools or resources that will worsen the operator's objectives. In addition, the proposed matching algorithm will reduce the possibility of utilizing zonal tools with high operational cost and insignificant effect on the operator's objective. This matching algorithm will reduce the overall operational costs of ZEMOS. Furthermore, the algorithm is independent of the study system, and it can be applied on any zonal tools or objectives, which agrees with the modularity concept of ZEMOS.

The matching process is a planning process that is performed in any of the following cases: the initial installation of ZEMOS, the installation of additional tools, and the extension of the number of the saved objectives.

Once the matching process is finished, tools that have the lowest operational costs and the highest effects on the objectives are selected (Selected Tools from Available Tools 5). Using the selected tools 5, Optimization Techniques 6 are applied to find the Ideal State 7 of the zone of interest.

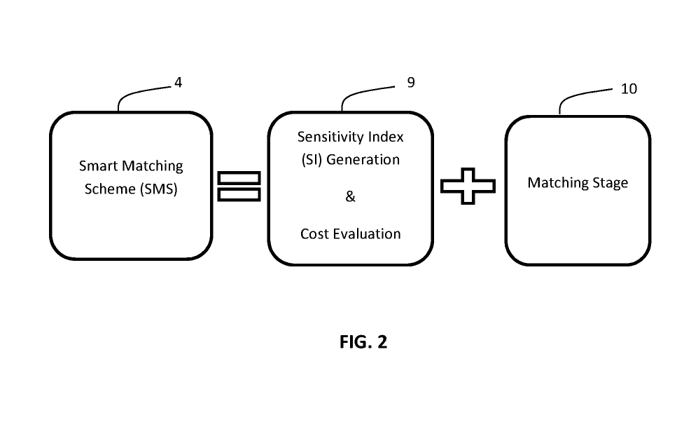

The Smart Matching Scheme 4 consists of two main stages shown in FIG. 2: Sensitivity Index (SI) Generation and Cost Evaluation 9, and Matching Stage 10.

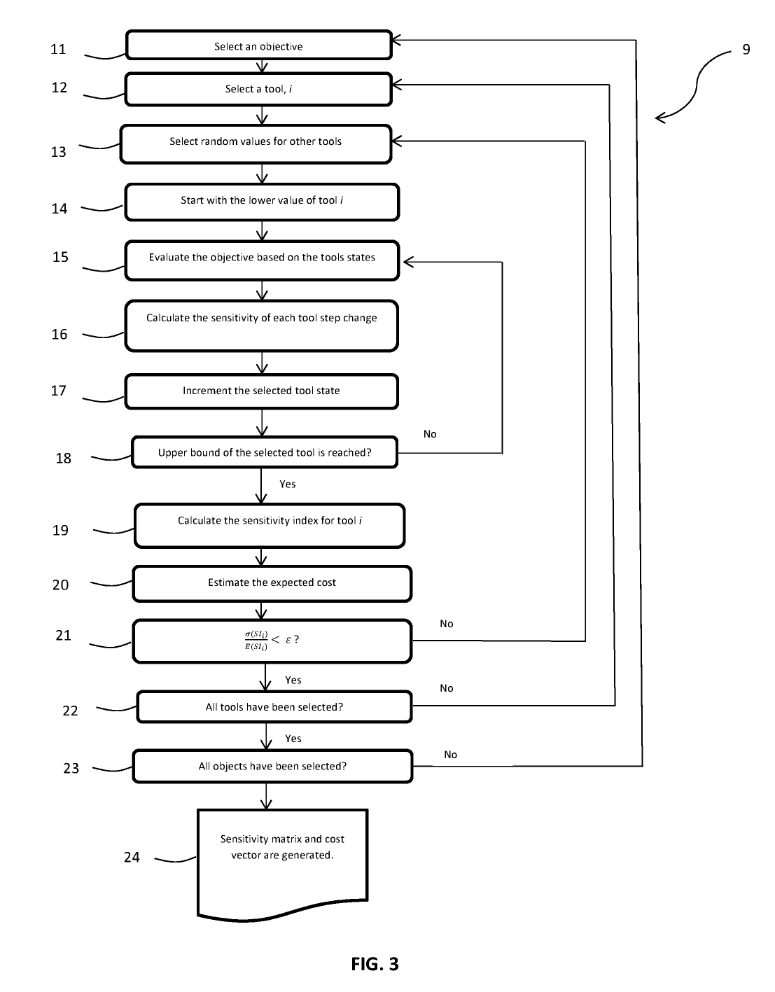

The general algorithm of the SI Generation and Cost Evaluation 9 is presented in FIG. 3. Different objectives may be chosen by the operator, and as a first step, one objective is selected (11) among the group of operator's objectives. Further, one tool i is selected (12) among a number of available tools. The lower and upper bounds of the selected tool is identified, and the tool values are divided into N fixed width states. Random values are selected for the rest of the unselected tools (13). The procedure starts with the lower value of the selected tool (14), and the desired operator objective is evaluated (15) based on the current tools state using stochastic Monte-Carlo simulation. The sensitivity of each tool step change (16) is calculated as,

$${D}_{jk}^{i} = \frac{{Obj}_{k}^{i} - {Obj}_{j}^{i}}{{S}_{k}^{i} - {S}_{j}^{i}}$$

Where Dⁱⱼₖ is the deviation of the operator's objective when tool i is changed from state j to state k, Objⁱⱼₖ is the value operator's objective when tool i is at state k, Objⁱⱼ is the value operator's objective when tool i is at state j, Sⁱₖ is the value of tool i at state k, and Sⁱⱼ is the value of tool i at state j. The selected tool state is incremented (17), and checked if the upper bound is reached (18). If the upper bound is not reached the process goes to (15), otherwise it goes to (19) and calculate the sensitivity index for tool i as follows,

$${SI}_{i} = \frac{{D}_{12}^{i} + {D}_{23}^{i} + … {D}_{jk}^{i} … + {D}_{( N - 1 ) N}^{i}}{N - 1}$$

The expected cost (20) for a step change of tool i can be estimated as,

$${C}_{i} = \frac{{C}_{12}^{i} + {C}_{23}^{i} + … {C}_{jk}^{i} … + {C}_{( N - 1 ) N}^{i}}{N - 1}$$

with Cⱼₖⁱ being the cost of changing the tool i from state j to state k.
The convergence criterion (21) is

$$\frac{σ ( {SI}_{i} )}{E ( {SI}_{i} )} \leq ɛ$$

Where σ(SIᵢ) is the standard deviation of the sensitivity index of tool i, E(SIᵢ) is the expected value of the sensitivity index of tool i, and ε is a selected small tolerance. If all tools have been selected (22) the process goes to step (23), otherwise it goes to (13) and it selects another tool. In (23) the algorithm checks whether all objects have been selected. If all objects have been selected the procedure is finished and the sensitivity matrix and vector are generated (24), otherwise it goes to (11) and it chooses another object. By the end of this algorithm, a sensitivity matrix is attached to the zonal tools showing their effect on each objective and a cost vector showing necessary cost of the step change of each tool. It is necessary to stress on the fact that this stage is a planning problem. As a result, time is not an issue at this stage.

After the SI Generation and Cost Evaluation 9, in the Matching Stage 10, tools and resources will be matched to the operator's objectives using the SI matrix and the cost vector. The matching process is a multi-objective optimization problem that will be solved in order to maximize the total SI, while minimizing the operational cost. The matching problem can be formulated as follows, Objective:

$$min ( F )$$

$$F = [ - {\sum }_{i = 1}^{M} ( {x}_{i}^{+} - {x}_{i}^{-} ) {SI}_{i , j} {\sum }_{i = 1}^{M} ( {x}_{i}^{*} - {x}_{i}^{-} ) {C}_{i} ]$$

### Subject to:

xᵢ⁺+xᵢ⁻≦1 ∀i=1,2,3 . . . M

xᵢ⁺,xᵢ⁻ε{0,1}

Where SI_{i,j} is the value of the sensitivity index of a step change of tool i on the objective j, Cᵢ is the operational cost of a step change of tool i, and x⁺ᵢ, x⁻ᵢ are the decision variables of selecting a step increase or a step reduction of tool i, respectively.

For the Optimization Techniques 6 and the decision making process, the system is studied for a single decision maker with single and multiple objectives. Genetic Algorithm (GA) is used to generate the required sets of solutions. GA is a heuristic search algorithm based on the mechanism of natural selection. The main reasons of utilizing GA in this research are: GA supports multi-objective optimization; they can be effective regardless of the nature of the objective functions and constraints; always generates an answer, which becomes better with time; fitness function can be changed from iteration to iteration, which allows incorporating new data in the model whenever they are available; and for large scale complex problem, GA can offer close to global optimum solution in a very short time compared to conventional gradient techniques.

Single objective decision maker: In the case of a single decision maker with a single objective, each chromosome will be a proposed solution set (tools' states) such as a DG set point, capacitors switching status or load curtailment reduction amount. With encoding the chromosome, the new tools' states are determined and then if all of constraints were considered, the system objective is calculated and that is the fitness value. This algorithm is repeated until a stopping criterion is achieved. In this research, the stopping criterion is usually a time limit provided by the decision maker.

Multiple objectives decision maker: In case of multiple objectives decision maker, GA can be efficiently used in order to identify the optimal non-dominated Pareto Front. The solutions set after each generation are ranked into a set of non-dominated fronts according to NSGA II (Non-dominated Sorting Genetic Algorithm II).

The main purpose of the decision-making process is to determine single solution in case of a multi-objective problem. To illustrate, a Pareto optimal set is generated using Genetics Algorithm, and then a search process is begun within the points generated in order to determine the best point. This decision-making technique uses an Lₚ-metrics, deviation, family as a measure of how close a solution is to an ideal point. A final decision is generated by following the algorithm in order to minimize the value of Lₚ. An Lₚ-metrics family is defined as follows:

$${L}_{p} ( x ) = {[ {\sum }_{i = 1}^{k} {w}_{i}^{p} {\vert \frac{{f}_{i} ( x ) - {f}_{i}^{0}}{{f}_{i max} - {f}_{i}^{0}} \vert}^{p} ]}^{\frac{1}{p}}$$

where k is the total number of objectives; f^{o} is the value of objective i at the ideal point; fᵢ(x) is the result of objective i corresponding to decision x; fᵢₘₐₓ is the worst value obtainable for objective i (maximum value of objective i in a minimization problem); and w^{p}ᵢ is the weight assigned to objective i.

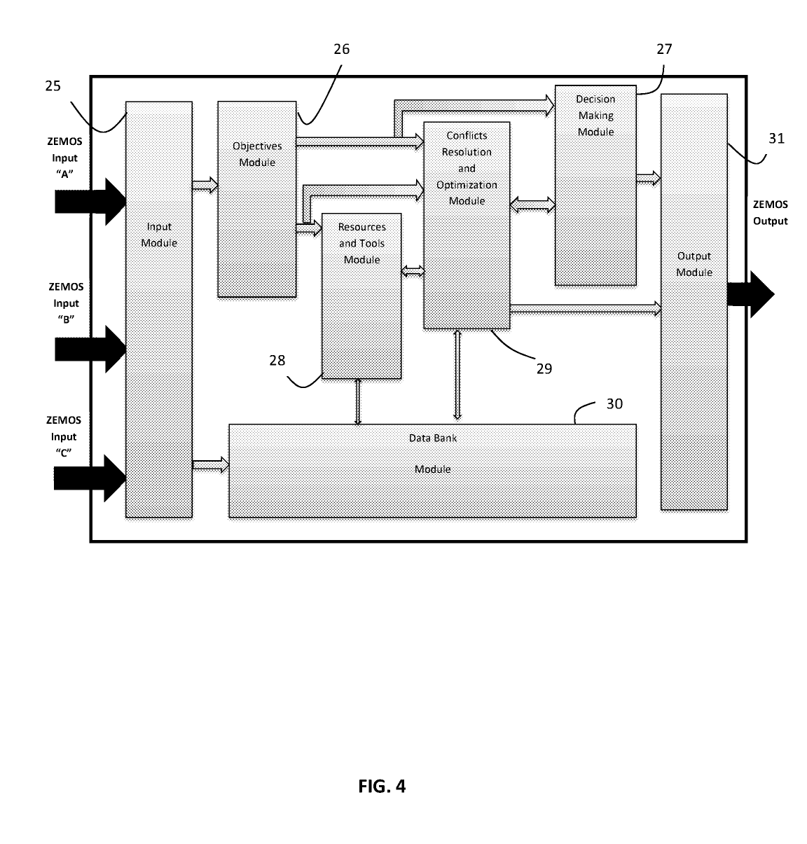

The basic structure of ZEMOS in a block diagram is presented in FIG. 4. Seven modules are used to construct the basic structure of ZEMOS.

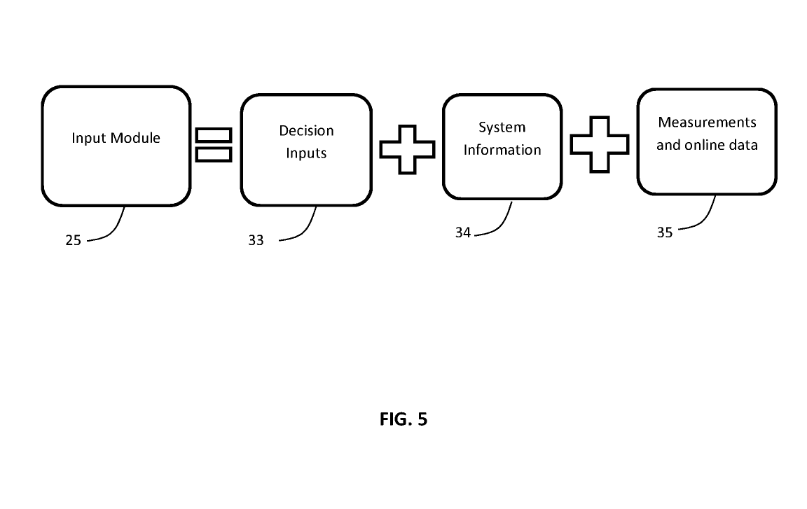

The input module 25 requires a set of input data that are collected by the input module. As shown in FIG. 5, ZEMOS Input Module 25 is divided into three main groups. Decision Inputs 33, System Information 34, and Measurements and Online Data 35.

The Decision Inputs 33 are the variables that should be specified by each decision maker (zone operator/owner) in order to control the operation of ZEMOS. Decision inputs are:
Objectives selector: This is the main input, which will determine the main objectives required by the decision maker only once and the process will be adaptive. This input will raise a flag that is used to determine the number of objectives requested by each decision maker.
Objectives priorities: This input indicates the operator's preferences of the objectives; accordingly, objectives priorities will be determined. This input will be used by the Decision Making Module 27 in order to evaluate a single solutions set.
Objectives acceptable limits: This input will be used by the Decision Making Module 27 to specify which point of the ZEMOS set of solutions will be excluded from the generated set.
Constraints: This input indicates different decision maker constrains. They will be adjusted by each decision maker only once and they will be stored in the Conflicts Resolution and Optimization Module 29. The stored constraints will not be changed unless the operator desires to readjust them.
Objectives duration: ZEMOS should include stochastic data forecasting techniques. Consequently, these forecasting functions acquire a time duration that is used as a forecasting time limit.
Decision maker's time limit: This time limit will be the stopping criteria for the ZEMOS calculations and operation until the ZEMOS output is generated.

The System Information 34 includes all the data that will indicate the system and components status, such as: distributed generators (number of dispatchable DGs, ratings, historical solar irradiance wind speed data), Loads (historical load data), Transmission lines (parameters, and transmission lines capacities), and utility energy prices.

The Measurements and Online Data 35 input represent the online data (readings) collected from different system meters such as: AMI, voltages, main feeder currents, present loading conditions (peak, light loads, demand etc.), system state (normal, emergency, and restoration).

Objectives Module 26: The main purpose of this module is to determine the objectives according to the decision maker requirements. The objectives are originally stored in the Objectives Module 26 and selected by the decision maker. It should be mentioned here that the objectives module is extendable in terms of both the number of objectives and the number of decision makers. The inputs of the Objectives Module 26 are determined by the Decision Inputs 33. The Objectives Module 26 has two output groups. The first output group is the number of decision makers, duration, constraints, priorities, time limit, objectives limits, and the number of objectives selected by each decision maker. This output group will be used by the Conflicts Resolution and Optimization Module 29, and Decision Making Module 27, which will be explained later. The second output group of the Objectives Module 26 is the types of objectives selected by each decision maker (operator/zone owner), which will be collected from each sub-module. The second output group will be used by the Resources and Tools Module 28. Moreover, this output group will be sent to the Conflicts Resolution and Optimization Module 29 in order to optimize the selected objectives.

Decision Making Module 27: The main purpose of the decision making module is to adopt a predetermined decision making approach to recommend a single solution that will fulfill all the decision maker's objectives. Meanwhile, the recommended optimal decision satisfies all the decision makers' operational constraints. The Decision Making Module 27 has two main inputs:
Set of optimum or equilibrium solutions points from Conflicts Resolution and Optimization Module 29.
Decision maker's objectives limits and objectives priorities from the Objectives Module 26.
   The outputs of Decision Making Module 27 will be a single point, which will be saved in the Output Module 31 as the final output of ZEMOS.

Resources and Tools Module 28: This module consists of a set of sub-modules; each represents a possible zonal controlled tool or resource that can be utilized to achieve a specific objective. For example a system tool might be a demand response, DG set points, capacitors switching states, percentage load shedding, or phase swapping options. All the available zonal tools and resources in the controlled zone are stored in the Resources and Tools Module 28. There are two vectors attached to each tool, which indicate the lower and the upper bounds of all the tool input variables (states). Resources and Tools Module 28 will be activated by the second output group of the Objectives Module 26. The zonal objectives are matched to the existing tools using a probabilistic smart matching algorithm. Next to activating a specific tool by an objective, the values of that tool states will be recognized as decision variables that need to be optimally evaluated to fulfill the corresponding objective. On the whole, Resources and Tools Module 28 has two inputs groups and one output group:
Inputs group “1”: This input is the Objectives Module 26 output, which carry the information about the tools/resources that need to be activated.
Inputs group “2”: This input is received from the Data Bank Module 30, which determines the base-case values of the inactivated tool's states.
Outputs group “1”: This is the Resources and Tools Module 28 output that will be sent to the Conflicts Resolution and Optimization Module 29, which indicates the lower and upper bounds for each tool.

Conflicts Resolution and Optimization Module 29: A number of optimization and conflict resolution algorithms will be stored in 29. The optimization algorithm is selected according to the number of objectives per decision maker, and the nature of the problem, which are determined from the Objectives Module 26. Currently, ZEMOS operation can be classified into two possible cases:
Single decision maker with single objective: In this case, only one decision maker requires a single objective. Consequently, the Conflicts Resolution and Optimization Module 29 generates a solution which is a single set of decision variables that fulfills the decision maker's objective.
Single decision maker with multi-objectives: The solution of this case does not offer a single solution. It is necessary to determine a set of points that all fit a predetermined definition for an optimum solution. For such a set of solutions, it cannot be said that one of these solutions is better than the other. This concept in defining optimal solutions is called Pareto optimality. The main goal is to find as many Pareto-optimal and feasible solutions as possible. The Conflicts Resolution and Optimization Module 29 inputs are:
   The outputs of the Objectives Module 26.
   The outputs of Resources and Tools Module 28 including the number of decision variables and their upper and lower bounds, as well as base-case states on the inactivated tools and resources.
In addition, the Conflicts Resolution and Optimization Module 29 needs to coordinate with the data processing sub-module in order to evaluate necessary parameters and electrical quantities. The generated optimal set of solution points are stored in the Output Module 31 and, in the meantime, are given to the Decision Making Module 27.

Data Bank Module 30: The data bank module is divided into three sub-modules: data storage sub-module, data forecasting sub-module and data processing sub-module.
Data storage sub-module: The goal of the data storage sub-module is to store the necessary data for the ZEMOS operation, such as, base-case values of zone resources and tools (loads values, capacitor's switching states, DGs powers), present loading, and distributed generations states, system status (emergency, normal, and restoration), historical data (renewable DGs powers, loading).
Data Forecasting Sub-module: Typical distribution systems consist of a large number of elements that are stochastic in nature such as electrical loads and renewable energy sources. Accordingly, ZEMOS must forecast ahead the behavior of the study system within the operator specified period by predicting the power output of renewable sources and the demands of the electric loads. This is the main function of the data forecasting sub-module. Generally, a set of data forecasting models and techniques will be developed and stored inside this sub-module. As with the rest of ZEMOS modules, the number of stored models and techniques can be extended independently.
Data processing sub-module: This sub-module is necessary in order to process the data that will be used by the Conflicts Resolution and Optimization Module 29. Data processing normally implicates evaluation of system objectives such as energy loss, unbalance, and emissions rate, etc. In addition, a data processing sub-module is used for simulating the system load flow based on: the stored data, system resources states and predicted stochastic data. The data processing sub-module requires the following inputs: data storage sub-module output, data forecasting sub-module output, and decision variables optimal states (output from 29).

Output Module 31: In order to fulfill the decision makers' objectives, ZEMOS is expected to generate optimal set points for the zonal resources and tools that will fulfill the decision makers' objectives. The expected outputs from ZEMOS are:
Systems tools and resources that need to be controlled.
Recommended optimal states of the controlled resources and tools, such as, amount of load demands that will be curtailed, or shifted, amount of distributed generation output powers, load phase swapping states, capacitors switching states, voltage regulators tap settings, reference values for control systems.
The time instant and the duration of the recommended states.

What is claimed is:

1. A zonal energy management and optimization system (ZEMOS) to manage available zonal tools and resources to fulfill a decision maker's objectives at minimum operational costs and within the decision maker's time limit, the system comprising:
a. an input module receiving inputs from said decision maker, a zonal system, and an online measurement system;
b. an objectives module to store objectives being selected according to said decision maker's objectives;
c. a resources and tools module to store available zonal tools and resources being selected based on said decision maker's objectives;
d. a conflict resolution and optimization module to store conflict resolution and optimization algorithms being used based on the number of said objectives and the nature of said objectives;
e. a data bank module to store zonal system data for forecasting and processing of said zonal system data;
f. a decision making module to make decision based on said decision maker's objectives, objectives limits, objectives priorities, and an optimum state; and
g. an output module to generate output for said zonal system to fulfill said decision maker's objectives.

2. The system of claim 1, wherein said input module from the decision maker comprising:
a. plurality of objectives;
b. priorities of said objectives according to the decision maker;
c. limits of said objectives; and
d. a time limit.

3. The system of claim 1, wherein said input module from said zonal system, comprising of distributed generators, number of dispatchable distributed generators, environmental data, historical load data, and energy prices.

4. The system of claim 1, wherein said input module from said online measurement system comprising of:
a. online data readings collected from plurality of zonal system meters comprising:
voltages; and
main feeder currents;
b. online data readings collected from plurality of advanced metering infrastructure (AMI);
c. electrical loading conditions, and
d. zonal system state being selected from normal state, emergency state, and restoration state.

5. The system of claim 1, wherein said objectives module comprising:
a. a first output group comprising of the number of decision makers, duration, constraints, priorities, time limit, objectives limits, and the number of objectives selected by each decision maker, wherein said first output group is used by said conflict resolution and optimization module, and said decision making module;
b. a second output group comprising of the objectives selected by each decision maker, and being used by said resources and tools module, and said conflicts resolution and optimization module, in order to optimize the objectives, and
c. said input module from the decision maker.

6. The system of claim 1, wherein said resources and tools module comprising of available zonal tools and resources comprising of demand response, distributed generation set points, capacitors switching states, percentage load shedding, and phase swapping options.

7. The system of claim 1, wherein said resources and tools module comprising:
a. a first input group from said objectives module to match and activate said available zonal tools and resources to said decision maker's objectives using a probabilistic smart matching scheme;
b. a second input group from said data bank module to determine base-case values from inactivated states of said available zonal tools and resources; and
c. an output group to said conflict resolution and optimization module to indicate lower and upper bounds of said available zonal tools and resources.

8. The system of claim 1, wherein said conflict resolution and optimization module comprising:
a. plurality of optimization and conflict resolution algorithms;
b. an input group 1 from said objectives module;
c. an input group 2 from said resources and tools Module;
d. an input group 3 from said data bank module, and
e. an output group 1 to said decision making module and said output module to indicate said optimum state.

9. The system of claim 1, wherein said data bank module comprising:
a. data storage sub-module to store zonal system data for the ZEMOS operation, comprising:
base-case values of said available zonal tools and resources;
present loadings;
distributed generation states;
zonal system state, and
historical data (renewable distributed generation powers, and loadings).
b. data forecasting sub-module to store sets of data forecasting models and techniques to forecast ahead the behavior of the zonal system; and
c. data processing sub-module to process zonal system data to be used by said conflict resolution and optimization module.

10. The system of claim 1, wherein said decision making module comprising:
a. an input group from said conflicts resolution and optimization module being said optimum states;
b. an input group from said objectives module being decision maker's objectives limits, and objectives priorities, and
c. an output group being a single optimum state to be stored in said output module as a final output of ZEMOS.

11. The system of claim 1, wherein said decision making module being based on minimizing the value of an Lₚ-metrics family defined as
$${L}_{p} ( x ) = {[ {\sum }_{i = 1}^{k} {w}_{i}^{p} {\vert \frac{{f}_{i} ( x ) - {f}_{i}^{0}}{{f}_{i max} - {f}_{i}^{0}} \vert}^{p} ]}^{\frac{1}{p}}$$
wherein k represents the total number of objectives, f^{o} represents the value of objective i at the ideal point, fᵢ(x) represents the result of objective i corresponding to decision x, fᵢₘₐₓ represents the worst value obtainable for objective i (maximum value of objective i in a minimization problem), and w^{p}ᵢ represents the weight assigned to objective i.

12. The system of claim 1, wherein said output module comprising of:
a. said available zonal tools and resources that need to be controlled;
b. recommended optimal states of said available zonal tools and resources comprising of amount of load demands to be curtailed/shifted, amount of distributed generation output powers, load phase swapping states, capacitors switching states, voltage regulators tap settings, and reference values for control systems;
c. time instant of said recommended optimal states; and
d. duration of said recommended optimal states.

13. A Smart Matching Scheme (SMS) to match the available zonal tools and resources to the decision maker's objectives comprising: a sensitivity index generation method and a cost evaluation method; and a matching stage algorithm.

14. The smart matching scheme of claim 13, wherein said sensitivity index generation and said cost evaluation method comprising:
a. calculating the sensitivity of each tool step change as,
$${D}_{jk}^{i} = \frac{{Obj}_{k}^{i} - {Obj}_{j}^{i}}{{S}_{k}^{i} - {S}_{j}^{i}}$$
wherein Dⁱⱼₖ represents the deviation of the operator's objective when tool i is changed from state j to state k, Objⁱₖ represents the value operator's objective when tool i is at state k, Objⁱⱼ represents the value operator's objective when tool i is at state j, Sⁱₖ represents the value of tool i at state k, and Sⁱⱼ represents the value of tool i at state j;
b. calculating the sensitivity index for tool i as,
$${SI}_{i} = \frac{{D}_{12}^{i} + {D}_{23}^{i} + … {D}_{jk}^{i} … + {D}_{( N - 1 ) N}^{i}}{N - 1}$$
wherein the tool values are divided into N fixed width states; and
c. calculating the expected cost for a step change of tool i as,
$${C}_{i} = \frac{{C}_{12}^{i} + {C}_{23}^{i} + … {C}_{jk}^{i} … + {C}_{( N - 1 ) N}^{i}}{N - 1}$$
wherein Cⱼₖⁱ represents cost of changing the tool i from state j to state k.

15. A smart matching scheme of claim 13, wherein said matching stage algorithm comprising of a multi-objective optimization problem being solved in order to maximize the total sensitivity index, while minimizing the operational cost by minimizing the function:
$$F = [ - {\sum }_{i = 1}^{M} ( {x}_{i}^{+} - {x}_{i}^{-} ) {SI}_{i , j} {\sum }_{i = 1}^{M} ( {x}_{i}^{*} - {x}_{i}^{-} ) {C}_{i} ]$$
wherein SI_{i,j} represents the value of the sensitivity index of a step change of tool i on the objective j, Cᵢ represents the operational cost of a step change of tool i, and x⁺ᵢ, x⁻ᵢ represent the decision variables of selecting a step increase or a step reduction of tool i, respectively.
